(19) United States
(12) Patent Application Publication
(10) Pub. No.: US 2017/0206374 A1
(43) Pub. Date: Jul. 20, 2017

(54) CONTEXTUAL IDENTIFICATION USING MOBILE DEVICES

(71) Applicant: INTERNATIONAL BUSINESS MACHINES CORPORATION, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(21) Appl. No.: 14/996,947

(22) Filed: Jan. 15, 2016

(51) Int. Cl. G06F 21/62; H04L 29/06

(52) U.S. Cl. CPC G06F 21/6245; H04L 63/10; H04L 63/102

(57) ABSTRACT

Systems and methods for displaying a digital identification (ID) document on a mobile device. A computer implemented method includes: receiving a request for a digital identification document, wherein the request includes context data, and the request is received by a computer device from a user device; comparing, by the computer device, the context data to at least one pre-defined rule; creating, by the computer device, a version of the digital identification document based on the comparing; and transmitting, by the computer device, the created version of the digital identification document to the user device for displaying on the user device.

### BACKGROUND

The present invention relates generally to digital identification and, more particularly, to rendering a digital identification based on context.

Digital (electronic) identification for individuals is advancing as a replacement to physical identification documents. For example, many departments of motor vehicles are developing digital driver's license programs in which an individual may display their driver's license on their mobile computing device. Colleges and universities are also developing digital student identifications that can be displayed on a mobile device.

These digital identification programs are implemented as dedicated mobile applications (apps) on a user's mobile device. A user launches the app, logs in to an identification provider server, and the identification provider server returns a digital version of the user's identification document. The use of digital identification brings many advantages, such as the ability to update data in the identification (for example when a person changes their address) as soon as the update is needed, without needing to send out a new physical identification card. However, use of a digital identification still has some of the same limitations as a physical license. When a user shows their digital identification to another person, the other person can see all of the user's personal information that is contained in the digital identification. With today's heightened focus on privacy, this is a significant concern since the user may not wish to share all the information contained in the digital identification. For example, the user presenting the digital identification may be doing so only for age verification, and may not wish to present additional personal information to the other person.

### SUMMARY

In an aspect of the invention, a computer implemented method includes: receiving a request for a digital identification document, wherein the request includes context data, and the request is received by a computer device from a user device; comparing, by the computer device, the context data to at least one pre-defined rule; creating, by the computer device, a version of the digital identification document based on the comparing; and transmitting, by the computer device, the created version of the digital identification document to the user device for displaying on the user device.

In another aspect of the invention, there is a system for displaying a digital identification (ID) document on a mobile device. The system includes a server running an ID program comprising a context module, wherein the server is configured to: receive a request for the digital identification document from the mobile device, wherein the request includes context data; compare the context data to at least one pre-defined rule; create a version of the digital identification document based on the comparing; and transmit the created version of the digital identification document to the mobile device for displaying on the mobile device.

In another aspect of the invention, there is a computer program product for displaying a digital identification (ID) document on a mobile device. The computer program product includes a computer readable storage medium having program instructions embodied therewith. The program instructions are executable by a computing device to cause the computing device to: store a full version of a digital identification document of a user; receive a request for the digital identification document from a mobile device of the user, wherein the request includes context data; determine the context data satisfies at least one pre-defined rule; create a modified version of the digital identification document that includes less user data than the full version of the digital identification document; and transmit the modified version of the digital identification document to the mobile device for displaying on the mobile device.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 shows an exemplary environment in accordance with aspects of the invention.

FIGS. 3-5 show exemplary implementations in accordance with aspects of the invention.

FIG. 6 shows a flowchart of a method in accordance with aspects of the invention.

### DETAILED DESCRIPTION

The present invention relates generally to digital identification and, more particularly, to rendering a digital identification based on context. According to aspects of the invention, a digital identification provider creates a version of a user's digital identification based on a context, and transmits data defining the created version of the user's digital identification to the user's mobile device for displaying on the mobile device. Different versions of digital identification may be created for a same user based on different contexts. In embodiments, the digital identification provider stores user data associated with the user's digital identification, and the version of the user's digital identification that is created and provided to the user's mobile device includes only a subset of (less than all of) the entirety of the user data. In this manner, implementations of the invention permit a user to display only a portion of their user data in their digital identification, and prevent another person from seeing other portions of the user data that are not relevant to the context in which the digital identification is being shown.

In accordance with aspects of the invention, a user creates an account with a digital identification provider and installs an application program of the digital identification provider on their mobile device. In embodiments, when the user wishes to present their digital identification to another person, the user launches the application program and authenticates themselves in the application program. Upon authentication, the mobile device transmits data to the identification provider requesting the digital identification of the user. In embodiments, the data transmitted to the identification provider includes contextual data, such as a location of the user's mobile device. The digital identification provider compares the contextual data to predefined rules (e.g., profiles), creates a version of the digital identification based on the comparison, and transmits the created version of the digital identification to the mobile device. The user mobile device then displays (e.g., visually renders) the created version of the digital identification on a visual display.

In embodiments, the digital identification provider stores user data associated with the user and associates the user data with the user's account. For example, in an implementation where the digital identification is a digital driver's license, the user data stored by the identification provider may include the user's photograph, license number, first name, middle name, last name, date of birth, height, weight, gender, and home address. The digital identification provider may store a full version of the user's digital identification, e.g., a digital driver's license that includes all the user data.

In embodiments, the user and the identification provider may specify different profiles (e.g., rules) that define different subsets of the user data to be included in the user's digital identification in a given situation. For example, the user may specify a user profile defining that, in a first context, the only data included in the created digital identification is the user's photograph and an indication of whether the user is of a certain age. As another example, the identification provider may specify a provider profile defining that, in a second context, the only data included in the created digital identification is the user's first name, middle name, last name, photograph, and home address. In this manner, based on the context in which the digital identification is being requested and used, the digital identification that is created and provided to the mobile device may be a modified version that includes less user data than is present in the full version of the user's digital identification.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

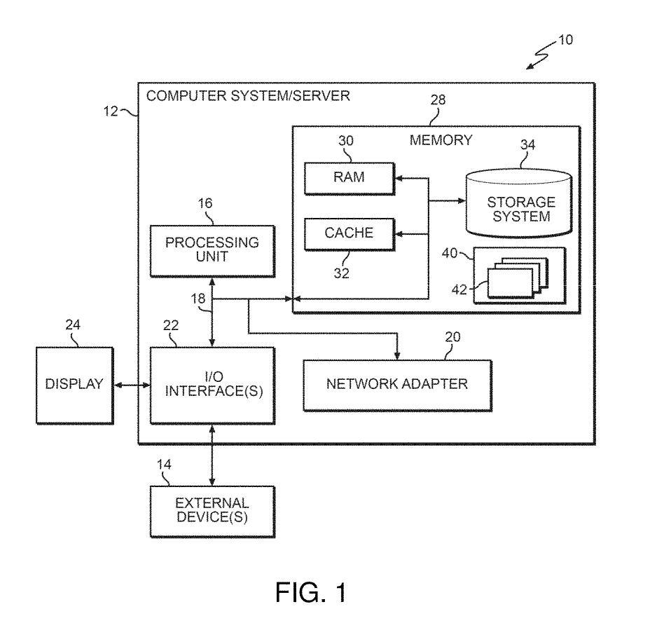

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

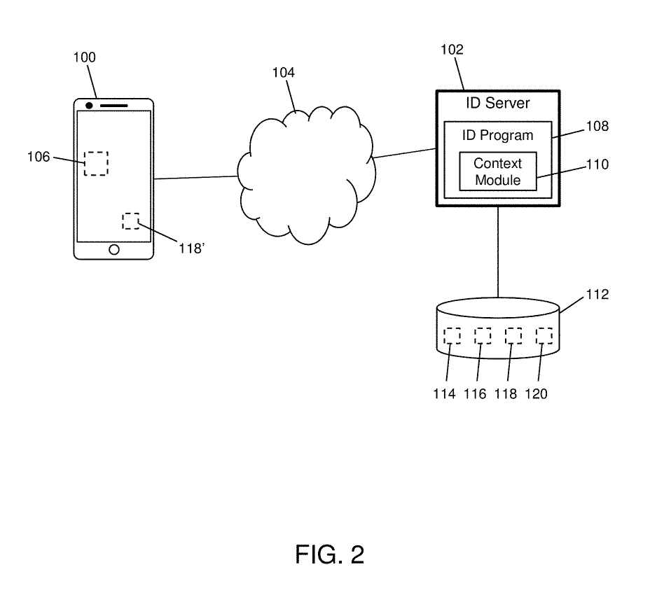

FIG. 2 shows a block diagram of an exemplary environment in accordance with aspects of the invention. In embodiments, the environment includes a mobile device 100 that communicates with an identification (ID) server 102 via a network 104. The mobile device 100 may comprise any suitable mobile computer device such as a smart watch, smartphone, tablet computer, laptop computer, etc. In embodiments, the mobile device 100 includes an ID app 106, which is a software application program (e.g., a mobile app) that is configured to communicate to the ID server 102. The network 104 may be any suitable computer network such as, for example, a LAN, WAN, or the Internet. The ID server 102 may be a computer system 12 as shown in FIG. 1, and may run an ID program 108 including a context module 110 that correspond, respectively, to program/utility 40 and program module 42 of FIG. 1. The ID server 102 may include or have access to data storage system 112, which may be similar to storage system 34 of FIG. 1.

In embodiments, the mobile device 100 is associated with a user (e.g., an individual person) and the ID server 102 is associated with a digital identification provider. The digital identification provider may comprise an entity that issues identification documents to individuals, such as a department of motor vehicles or an educational institution, for example.

As shown in FIG. 2, the ID server 102 stores user data 114 in the storage system 112. The user data 114 may comprise any suitable data, and may be provided by the user of the mobile device 100 or assigned by the digital identification provider. In an exemplary implementation where the digital identification provider provides a digital identification in the form of a digital driver's license, the user data 114 may include: a digital image (photograph) of the user; a user license number (assigned by the provider); user first name; user middle name; user last name; user date of birth; user height; user weight; user gender; and user home address. Aspects of the invention are not limited to these types of user data, and any desired user data may be used. The ID server 102 may store (in the storage system 112) a full version digital identification document 116 that includes all the user data 114. In the exemplary implementation using a driver's license, the full version digital identification document 116 is a digital version of a driver's license associated with the user of mobile device 100.

In embodiments, a user of the mobile device 100 may launch the ID app 106 to request a copy of their digital identification document for displaying on their mobile device 100. The ID server 102 receives the request and provides data defining a version of the user's digital identification document to the mobile device 100. The version of the user's digital identification document may be the full version (e.g., 116) or a modified version that includes less user data than the full version. In a preferred embodiment, the data provided from the ID server 102 to the mobile device 100 is not stored locally on the mobile device 100; instead, the data is provided in a manner such that the user's digital identification is displayed on a temporary basis and is not stored in persistent memory of the mobile device 100 after being displayed on the mobile device 100.

In aspects, plural different users may register with the digital identification provider, such that the ID server 102 stores different user data 114 and identification documents 116 for each respective user. In the exemplary implementation using a driver's license, each different user has their own user data 114 and identification document 116 in the form their personalized driver's license. Moreover, each user can employ a copy of the ID app 106 on their respective mobile device to access the ID server 102 for displaying their own driver's license on their mobile device.

Still referring to FIG. 2, the ID server 102 may also store a user profile 118 and a provider profile 120 in the storage system 112. In embodiments, the user profile 118 is a data structure that is created by the user of the mobile device 100. The user profile 118 allows a user to specify a subset of the user data 114 that is to be included in the user's digital identification in a predefined context. For example, the user profile 118 may specify that when the mobile device 100 is located at a particular location (e.g., a restaurant) during predefined hours, the user's digital identification will only include the digital image (photograph) of the user and an indication of whether the user is over or under a certain age (e.g., twenty-one years old). Alternatively to being stored on the storage system 112, the user profile 118 may be stored on the mobile device 100 as indicated at reference number 118′. The user profile 118 applies only to the particular user that created that profile, and does not apply to other users of the ID app 106. A single user may define plural different user profiles 118.

In embodiments, the provider profile 120 is created by the digital identification provider that is associated with the ID server 102. The provider profile 120 may define rules that apply to all users of the ID app 106, e.g., all users that have user data 114 and identification documents 116 stored in the storage system 112. For example, the provider profile 120 may define that when the mobile device is located at a particular location (e.g., a post office), the user's digital identification will include at least the digital image (photograph) of the user, the user first name, the user last name, and the user home address. The digital identification provider may define plural different provider profiles 120.

A location specified in a profile (user profile 118 and provider profile 120) may be defined using a category or coordinates. As an example of a category, a location may be defined as a restaurant, post office, etc. In embodiments, when requesting the user's digital identification from the ID server 102, the mobile device 100 includes its coordinates (e.g., global positioning system (GPS) coordinates) with the request that is sent to the ID server 102. In embodiments, the context module 110 is configured to compare the coordinates received from the mobile device 100 to the locations stored in the profiles 118 and 120, in order to determine whether any of the profiles 118 and 120 apply to the request for the user's digital identification.

In embodiments, when a location in the profile (118 or 120) is defined using coordinates, the context module 110 compares the coordinates received from the mobile device 100 to the coordinates in the profile. The profile is deemed to apply to the request for the user's digital identification when the coordinates received from the mobile device 100 match (e.g., overlap or coincide with) the coordinates in the profile.

In embodiments, when a location in the profile (118 or 120) is defined using a category, the context module 110 attempts to determine a category of location of the mobile device 100 by comparing the coordinates received from the mobile device 100 to predefined coordinates of predefined categories of locations. For example, the context module 110 may store or have access to a map that includes locations defined by categories, e.g., restaurant, post office, library, sports arena. The context module 110 may use the coordinates received from the mobile device 100 and the locations on the map to determine a category of location of the mobile device 100. The context module 110 may then compare the determined category of location of the mobile device 100 to the category of location defined in the profile. The profile is deemed to apply to the request for the user's digital identification when the determined category of location of the mobile device 100 matches (e.g., is the same as) the category of location defined in the profile.

In embodiments, when the context module 110 determines that only one of the user profile 118 and provider profile 120 applies to the request received from the mobile device 100, then the rules defined in the applicable profile are used to create the version of the user's digital identification that is provided to the mobile device 100. In further embodiments, when the context module 110 determines that both the user profile 118 and provider profile 120 apply to the request received from the mobile device 100, then the rules defined in the provider profile 120 are used to create the version of the user's digital identification that is provided to the mobile device 100. In this manner, the provider profile 120 trumps the user profile 118. However, aspects of the invention may be implemented the other way around, i.e., with the user profile 118 controlling when both profiles apply. In additional embodiments, when the context module 110 determines that neither the user profile 118 nor the provider profile 120 apply to the request received from the mobile device 100, then as a default state the full version digital identification document 116 is provided to the mobile device 100.

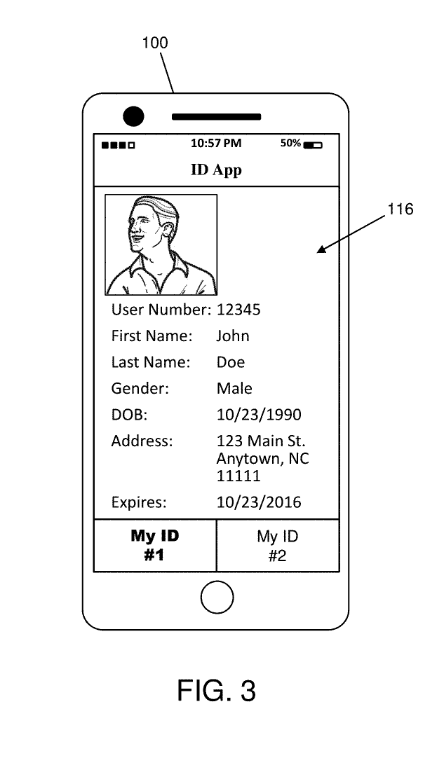

FIGS. 3-5 show examples of different versions of a user's digital identification document displayed on the user's mobile device 100. In FIG. 3, the full version of the digital identification document 116 is displayed on the mobile device 100. In this exemplary case, the full version of the digital identification document includes: user photograph; user number (e.g., driver's license number assigned by the digital identification provider); user first name; user last name; user gender; user DOB (date of birth); user home address; and expiration date of the driver's license (assigned by the digital identification provider). The full version of the digital identification document 116 may be provided to the mobile device 100 by the ID server 102 when the user specifically requests the full version and/or when no profiles (118 or 120) apply to the context data included in the request.

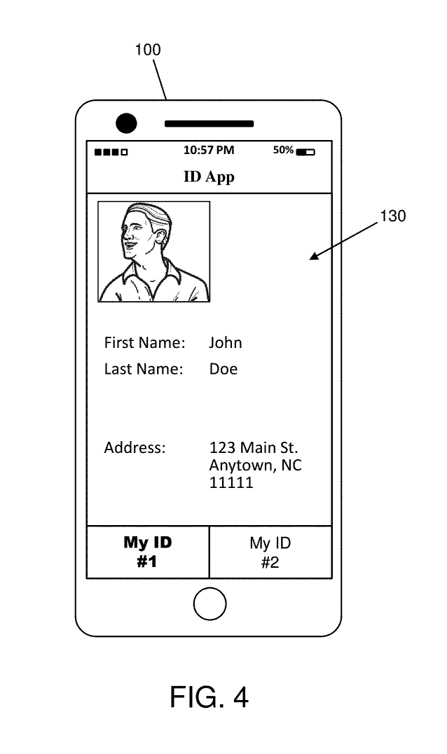

In FIG. 4, a first modified version of the digital identification document 130 is displayed on the mobile device 100. In this example the user (with their mobile device 100) is located at a post office during opening hours to collect a package. When the post office employee asks to see the user's ID, the user launches the ID app 106, authenticates, and initiates a request to the ID server 102. The request includes the GPS location of the mobile device 100. The ID server 102 receives the request and the context module compares the GPS location of the mobile device 100 to locations contained in profiles 118 and 120. The context module 110 determines that the GPS location of the mobile device 100 matches a location defined in one of the provider profiles 120 (e.g., a post office). The context module 110 then causes the ID program 108 to create a modified version of the digital identification document based on the rules contained in the matching provider profile 120. In this example, the matching provider profile 120 specifies that for this location the modified version of the digital identification document includes: user photograph; user first name; user last name; and user home address. The other user data (e.g., user number, gender, DOB, expiration date) is not included. The ID program 108 to creates the modified version of the digital identification document 130 and transmits it to the mobile device 100 for display thereon.

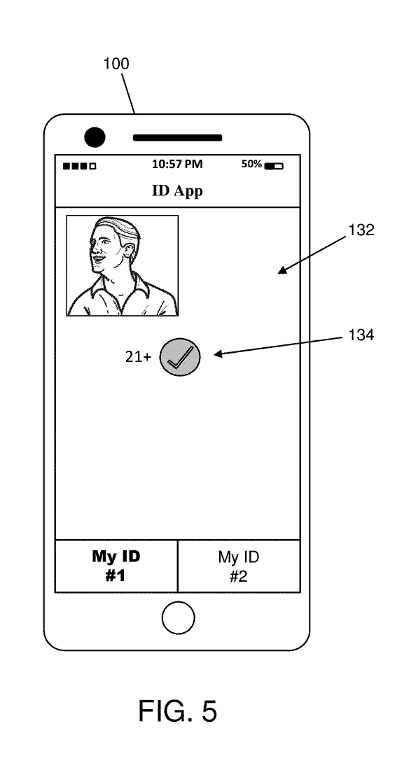

In FIG. 5, a second modified version of the digital identification document 132 is displayed on the mobile device 100. In this example the user (with their mobile device 100) is located at a restaurant during opening hours to collect a package. When the restaurant employee asks to see the user's ID (e.g., for age verification to serve a beverage), the user launches the ID app 106, authenticates, and initiates a request to the ID server 102. The request includes the GPS location of the mobile device 100. The ID server 102 receives the request and the context module compares the GPS location of the mobile device 100 to locations contained in profiles 118 and 120. The context module 110 determines that the GPS location of the mobile device 100 matches a location defined in one of the user profiles 118 (e.g., restaurant). The context module 110 then causes the ID program 108 to create a modified version of the digital identification document based on the rules contained in the matching user profile 118. In this example, the matching user profile 118 specifies that for this location the modified version of the digital identification document includes: user photograph; and an indicator 134 of whether the user is older or younger than twenty-one years old. The other user data (e.g., user number, user first name, user last name, gender, DOB, home address, expiration date) is not included. The ID program 108 to creates the modified version of the digital identification document 132 and transmits it to the mobile device 100 for display thereon.

Still referring to FIG. 5, in embodiments the ID program 108 modifies the user data 114 when creating the modified version of the digital identification document. For example, as shown in FIG. 5, the ID program 108 generates the user's digital identification document with an indicator 134 of whether the user is over a certain age, rather than including the user's DOB. In this manner, implementations of the invention protect the user's privacy by redacting user data that is not relevant to the context in which the digital identification document is being requested and used.

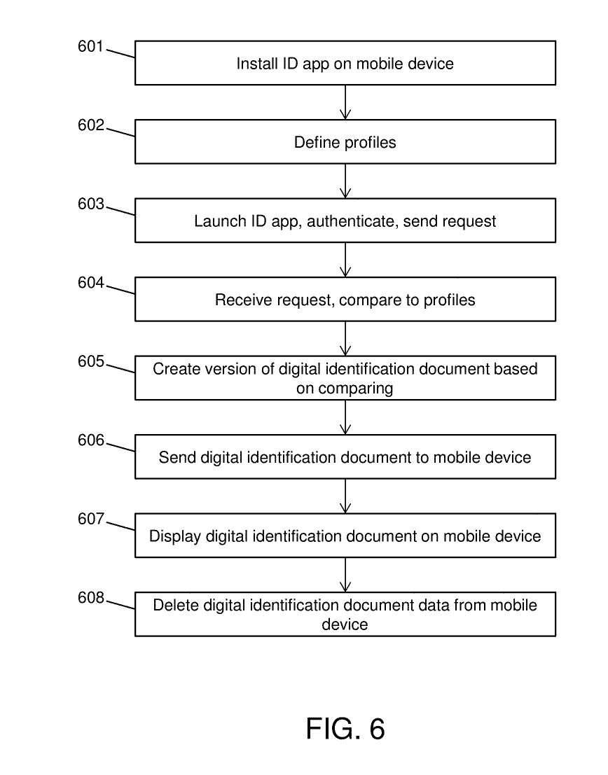

FIG. 6 shows a flowchart of a method in accordance with aspects of the invention. Steps of the method of FIG. 6 may be performed in the environment illustrated in FIG. 2 and are described with reference to elements shown in FIGS. 2-5.

FIG. 6 depicts a method of displaying a digital identification document on a mobile device in accordance with aspects of the invention. At step 601, a user installs the ID app 106 on their mobile device 100. This may be performed using conventional techniques, such as downloading the ID app 106 from a website or app store. Step 601 may also include the user registering with the digital identification provider, e.g., opening an account and providing user data 114. Step 601 may also include the digital identification provider storing the user data 114 and creating a full version of the user's digital identification document 116, e.g., a driver's license.

At step 602, profiles are created by the user and/or the digital identification provider. The user may use the ID app 106 on their mobile device 100 to define one or more user profiles 118. Each user profile 118 may include context data (e.g., location, time of day, etc.), and an indication of how to modify the digital identification document when the context data is satisfied. The user profile 118 may be stored on the user device 100 or at the digital identification provider. Provider profiles 120 are created and stored by the digital identification provider, and may include context data (e.g., location, time of day, etc.), and an indication of how to modify the digital identification document when the context data is satisfied.

At step 603, the user wishes to display their digital identification document on their mobile device 100. Accordingly, the user launches the ID app 106 on their mobile device 100, authenticates, and sends a request to the ID server 102. The user authentication may utilize conventional techniques, such as user name and password, biometrics, etc. The request that is sent from the mobile device 100 to the ID server 102 includes the GPS location of the mobile device. When the user has one or more user profiles 188 stored on the mobile device 100, the user profile(s) 188 are sent with the request.

At step 604, the ID server 102 receives the request and compares the request to applicable profiles. In embodiments, the context module 110 determines which user profiles 118 are associated with the request user. The context module 110 then compares the context data in the request (e.g., the mobile device GPS location) to the context data in the applicable user profiles 118 and all provider profiles 120.

At step 605, the ID program 108 creates a version of the user's digital identification document based on the comparing from step 604. The digital identification document may be a full version of the user's digital identification document, may be modified based on a determined applicable user profile 118, or may be modified based on a determined applicable provider profile 120. A modified version may have less user data that the full version (e.g., as shown in FIGS. 4 and 5) and/or may have different data (e.g., similar to indicator 134).

At step 606, the ID server 102 send the user's digital identification document (created at step 605) to the mobile device 100. At step 607, the mobile device 100 receives and displays the digital identification document that was sent at step 606. At step 608, the mobile device 100 deletes the user data associated with the displayed digital identification document.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method for performing one or more of the processes described herein. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method, comprising:
receiving a request for a digital identification document, wherein the request includes context data, and the request is received by a computer device from a user device;
comparing, by the computer device, the context data to at least one pre-defined rule;
creating, by the computer device, a version of the digital identification document based on the comparing; and
transmitting, by the computer device, the created version of the digital identification document to the user device for displaying on the user device.

2. The method of claim 1, wherein the context data includes a location of the user device when the request is sent.

3. The method of claim 1, wherein the context data includes a time of day associated with the request.

4. The method of claim 1, wherein the at least one pre-defined rule comprises a user profile.

5. The method of claim 4, wherein the receiving the request comprises receiving the user profile from the user device.

6. The method of claim 4, wherein the at least one pre-defined rule comprises a provider profile.

7. The method of claim 6, wherein the created version of the digital identification document comprises:
a full version of the digital identification document when the context data does not satisfy both the user profile and the provider profile;
a first modified version of the digital identification document when the context data satisfies the provider profile but not the user profile; and
a second modified version of the digital identification document when the context data satisfies the user profile but not the provider profile.

8. The method of claim 7, wherein:
the full version includes all user data;
the first modified version includes a first subset of the user data;
the second modified version includes a second subset of the user data, different than the first subset of the user data.

9. The method of claim 1, wherein:
the user device comprises a mobile device; and
the computer device comprises a server that communicates with the mobile device via a computer network.

10. The method of claim 9, wherein the mobile device comprises one of a smartphone, smart watch, tablet computer, and laptop computer.

11. The method of claim 1, wherein the transmitting the created version of the digital identification document to the user device comprises transmitting instruction to delete, from the user device, user data associated with the created version of the digital identification document after displaying the created version of the digital identification document.

12. The method of claim 1, wherein a service provider at least one of creates, maintains, deploys and supports the computing device.

13. The method of claim 1, wherein steps of claim 1 are provided by a service provider on a subscription, advertising, and/or fee basis.

14. A system for displaying a digital identification (ID) document on a mobile device, comprising:
a server running an ID program comprising a context module, wherein the server is configured to:
receive a request for the digital identification document from the mobile device, wherein the request includes context data;
compare the context data to at least one pre-defined rule;
create a version of the digital identification document based on the comparing; and
transmit the created version of the digital identification document to the mobile device for displaying on the mobile device.

15. The system of claim 14, wherein the context data includes a location of the mobile device when the request is sent.

16. The system of claim 15, wherein the comparing comprises comparing the location of the mobile device to a location specified in the at least one pre-defined rule.

17. The system of claim 16, wherein the location specified in the at least one pre-defined rule is defined by coordinates or a category.

18. The system of claim 14, wherein:
the comparing includes determining that the context data satisfies the at least one pre-defined rule; and
the created version of the digital identification document is modified to include less user data than a full version of the digital identification document.

19. A computer program product for displaying a digital identification (ID) document on a mobile device, the computer program product comprising a computer readable storage medium having program instructions embodied therewith, the program instructions executable by a computing device to cause the computing device to:
store a full version of a digital identification document of a user;
receive a request for the digital identification document from a mobile device of the user, wherein the request includes context data;
determine the context data satisfies at least one pre-defined rule;
create a modified version of the digital identification document that includes less user data than the full version of the digital identification document; and
transmit the modified version of the digital identification document to the mobile device for displaying on the mobile device.

20. The computer program product of claim 19, wherein:
the context data includes a location of the mobile device when the request is sent;
the determining comprises comparing the location of the mobile device to a location specified in the at least one pre-defined rule.
